(19) United States
(12) Patent Application Publication
(10) Pub. No.: US 2021/0295186 A1
(43) Pub. Date: Sep. 23, 2021

(54) COMPUTER-IMPLEMENTED SYSTEM AND METHOD FOR COLLECTING FEEDBACK

(71) Applicant: REALEYES OÜ, Tallinn Harju (EE)

(72) Inventors: Elnar HAJIYEV, Harju (EE); Martin SALO, Harju (EE)

(21) Appl. No.: 17/262,639

(22) PCT Filed: Aug. 2, 2019
(86) PCT No.: PCT/EP2019/070912

§ 371 Date: Jan. 22, 2021

(30) Foreign Application Priority Data
Aug. 9, 2018 (GB) 1812986.6

(51) Int. Cl. G06N 5/04; G06F 16/903

(52) U.S. Cl. CPC G06N 5/04; G06F 16/90335

(57) ABSTRACT

A computer-implemented system in which information is obtained form a user using an automated (i.e. non-human, computerised) interface that is arranged to dynamically adapt questioning based on received feedback from the user. The automated interface may comprise: (i) an agent for extracting information (e.g. meaning, sentiment, etc.) from feedback information from the user and using it to determine a direction for further questioning, and (ii) an agent for controlling the manner in which the further questioning is expressed to the user. The interface may be embodiment as a feedback collection manager communicatively connected over a network with a client device to receive the feedback information, wherein the feedback collection manager comprises: an AI-based topic generator module configured to generate a queiy topic; and an automated interactive question generator for directing an interactive information exchange with the client device using the generated queiy topic.

### FIELD OF THE INVENTION

The invention relates to a computer-implemented system and method of collecting user feedback. In particular, the invention relating to web-based interactive information exchange in which an artificial intelligence (AI)-based entity drives the feedback collection process based on information collected from the user.

### BACKGROUND TO THE INVENTION

Certain types of media content, such as advertising, music videos, movies, etc., aim to induce changes in a consumer's emotional state. In the case of advertising, it may be desirable to translate this change in emotional state into performance, such as sales lift. For example, a television commercial may look to increase sales of a product to which it relates. There is demand for being able to evaluate the effectiveness of media content prior to publication.

Active feedback, which is also referred to as self-reported feedback, is sometimes used in attempts to determine or predict the performance of pieces of media content, such as video commercials. For active user feedback, users provide verbal or written feedback after consuming a piece of media content. For example, the users may complete a questionnaire, or may provide spoken feedback that can be recorded for analysis, e.g. manually or in an automated manner using speech recognition tools. Feedback may include an indication of emotional state experienced while consuming the piece of media content. Questionnaire-based feedback is typically highly structured to facilitate processing and comparison. For example, questionnaires may be have a hierarchical or decision tree type structure, which maps a distinct and inflexible questioning pathways.

It is known that emotional state data can also be measured in a passive manner, e.g. by collecting data indicative of a user's behavioural or physiological characteristics. In one example, facial responses can be used as passive indicators of experienced emotional state. Webcam video acquisition can be used to monitor facial responses, by capturing image frames as a piece of media content is consumed by a user. Emotional state can therefore be captured through the use of webcams, by processing video images.

Physiological parameters can also be good indicators of experienced emotional state. Many physiological parameters are not consciously controllable, i.e. a consumer has no influence over them. Examples of physiological parameters that can be measured include voice analysis, heartrate, heartrate variability, electrodermal activity (which may be indicative of arousal), breathing, body temperature, electrocardiogram (ECG) signals, and electroencephalogram (EEG) signals.

The behavioural characteristics of a user may manifest themselves in a variety of ways. References to “behavioural data” or “behavioural information” herein may refer to visual aspects of a user's response. For example, behavioural information may include facial response, head and body gestures or pose, and gaze tracking. In practice, it can be desirable to use a combination of raw data inputs comprising behavioural data, physiological data and self-reported data in order to obtain emotional state information. A combination of raw data from two or three of the sources mentioned above may be useful in identifying “false” indicators. For example, if emotional state data derived from all three sources overlaps or is aligned, it gives more confidence in the obtained signal. Any inconsistency in the signal may be indicative of a false reading.

### SUMMARY OF THE INVENTION

At its most general, the present invention proposes a system in which information is obtained form a user using an automated (non-human, computerised) interface that is arranged to dynamically adapt the questioning based on received feedback from the user. The automated interface may comprise: (i) an agent for extracting information (e.g. meaning, sentiment, etc.) from feedback information from the user and using it to determine a direction for further questioning, and (ii) an agent for controlling the manner in which the further questioning is expressed to the user.

According to one aspect of the invention, there may be provided a computer-implemented system for collecting user feedback, the system comprising: a client device configured to collect and communicate feedback information from a user; and a feedback collection manager communicatively connected over a network with the client device to receive the feedback information, wherein the feedback collection manager comprises: an AI-based topic generator module configured to generate, using feedback information received from the client device, a query topic; and an automated interactive question generator for directing an interactive information exchange with the client device using the generated query topic.

The feedback collection manager may be computer-implemented entity that executes on one or more processor in a computing device, e.g. server or the like, connected over the network with the client device. The client device may be any computing device capable of network communication to engage n the interface information exchange. For example, the client device may be a computer (e.g. desktop, laptop, tablet), smartphone or other network-enabled communication platform.

The present invention may be particularly advantageous in its ability to utilise different types of data in the feedback information. In particular, in addition to the actual answer data provided by the user, e.g. the words or text supplied in response to a question, the feedback information may comprise behavioural or physiological data from the user, which in turn may be used to determine or understand the user's emotional state.

Thus, the feedback information collected by the client device may comprise answer data received in response to a question from the automated interactive question generator, and behavioural data collected from the user when providing the answer data. The answer data may be spoken, i.e. the interactive information exchange may be a dialogue in which the automated interactive question generator includes a natural language synthesis module for delivering questions in a spoken format. The feedback collection manager may include a speech recognition module for extracting feedback information from a spoken answer received from the user. The speech recognition module may parse the audio data to identify words that are indicative of the information content of the answer data. In addition, the speech recognition module may operate to detect other characteristics of the user's speech, e.g. pacing and pauses, which may be indicative of the user's mood.

The invention need not be limited to a spoken exchange. For example, alternatively or additionally the exchange may include a text-based element, e.g. a webchat or the like.

The behavioural data may comprise emotional state data for the user. For example, the feedback information collected by the client device may comprise facial images of the user. The emotional state data may be extracted from the facial images in any known manner. Additionally or alternatively, the behavioural data may be indicative of a user's attentiveness. For example, the collected behavioural data may be provided to an attentiveness model previously trained using attentiveness-labelled behavioural data from multiple users. The user's attentiveness may be used by the feedback collection manager to determine a duration of the interactive information exchange.

The feedback collection manager may be arranged to detect, based on the behavioural data and/or answer data collected from the user when providing the answer data, a sentiment, emotion or mood associated with the answer data. The automated interactive question generator may be arranged to use both the detected sentiment or mood and the generated query topic in the interactive information exchange with the client device. The sentiment may indicative of a user's attitude or strength of opinion. In one example, the sentiment or mood may be a detected valence, i.e. a measure of the user's positive/negative attitude. A positive valence may be indicative of positive emotion, such as happiness, whilst a negative valence may be indicative of a negative emotion, such as sadness. The sentiment may be a binary positive/negative indicator used in conjunction with a magnitude measurement that indicates the strength of feeling. The sentiment or mood may be detected in any known manner. The automated interactive question generator may use the detected sentiment or mood to select a tone or style for a subsequent question.

The behavioural data may comprise physiological data for the user. The physiological data may be used, e.g. in combination with the motional state data, to assist in determined the user sentiment.

The user feedback may be in relation to the user's exposure to a stimulus, wherein the client device is further configured to collect behavioural response data from the user during the user's exposure to the stimulus. The stimulus can be any interaction in which the user is involved. In one example, the stimulus may be consumption of media content, e.g. a video, an ad, music or the like. However, it made by any man-machine interaction for which feedback is desirable. The behavioural response data may be used to obtain emotional state information for the user whilst exposed to the stimulus. The behavioural response data may include facial images, from which the emotional state information is extracted.

The feedback information communicated by the client device may include the behavioural response data. Thus, the user's response to the stimulus may be used to generate the query topic. The behavioural response data may effectively represent another dimension against which the user's answer data can be compared in order to generate a query topic.

The feedback collection manager may be arranged to receive feedback information relating to different users from a plurality of client devices. The feedback information may relate to a common stimulus or a range of related or unrelated stimuli. The feedback information may be aggregated or otherwise combination to provide a feedback data repository from which insights into the user reaction can be obtained. The feedback manager may have an objective to grow or verify the feedback data repository. In some examples, the feedback data repository may relate to a given stimulus, or may represent feedback from a defined group of users. The feedback collection manager may be arranged to populate the feedback data repository with the answer data and any associated emotional state information that is obtained from the interactive information exchange.

The AI-based topic generator module may comprise a topic repository and a topic determination agent coupled to the topic repository. The AI-based topic generator module may be configured to extract input data from the feedback information, and apply the input data to the topic determination agent to generate output data that is indicative of the query topic. The input data may resemble a vector or other multidimensional data structure, such as a matrix. It may include components that correspond to or are indicative of any or all parts of the feedback information discussed above. The input data may resemble a vector or matrix with which a multi-dimensional space defined by the topic determination agent can be queried.

The topic repository may comprise a world model from which the topic determination agent is arranged to output a new query topic based on the input data. The world model may be created by training a machine learning algorithm using an external general data source, e.g. a news website or online encyclopaedia. The world model may thus may able to generate connections with subject matter that is not present in the stimulus or received feedback data. The topic generator module may thus be provided with an element of “curiosity” that is able to push the scope of the interactive information exchange beyond the information content of the stimulus.

Additionally or alternatively, the topic repository may comprise a database of previously received feedback data from which the topic determination agent is arranged to output a related query topic based on the input data. As discussed above, the previously received feedback data may be in relation to the same or a related stimulus, or may constitute a repository of all received feedback data. The topic determination agent in this case may thus be capable of providing a new query topic that is related to previous feedback data. For example, the new query topic may be to verify if a given answer data matches previously received feedback data and/or to explore or resolve any ambiguity.

Importantly, the topic repository (world model and/or database of previously received feedback data) may include behavioural data (in particular emotional state information) that is related to content that can form new query topics. The topic repository may be trained so that the emotional state information provides additional dimensions in the multi-dimensional space that can be queried by the input data. In this way, the direction of the interactive information exchange can take account of behavioural (emotional state) data in a manner that has not be possible heretofore.

The topic repository (world model and/or database of previously received feedback data) may be updated using received feedback data. The update may be performed periodically or in real time. The topic repository is thus capable of refreshing itself, thereby learning from the interactive information exchanges in which it is involved.

The topic determination agent may itself comprise a machine learning algorithm that is trained to identify relevant related information. The topic determination agent may be arranged to judge the related information (output data) against one or more objectives in order to determine the next query topic. The judgement may include a decision on whether or not to terminate the interactive information exchange. The decision to terminate may be based on a judgement or whether or not the objectives have been fulfilled. Additionally or alternatively, the decision to terminate may use the behavioural data collected from the user, especially in terms of the user's attentiveness or engagement with the interactive information exchange.

An objective may have one of two aims. One type of objective may be aimed at seek new information from the user. The algorithm in this case may be made “curious” by providing access to a world model that includes content that is independent of the feedback process. This type of objective may thus be aimed at maximising information in the answer data. A second type of objective may seek to verify or probe previously received feedback, e.g. by aggregating data around a particular subject or target (e.g. brand name). The two types of objective may be advantageously used in combination. For example, in a scenario where feedback is sought in relation to a movie or story, the first type of objective may, through its “curiosity”, identify that a certain character in the movie or story was linked to certain emotions. The second type of objective may then be used during feedback collection from other users to determine how common that link between character and emotion is across a group of users.

The machine learning algorithm may comprise any one of a model obtained from supervised learning, a adversarial network model and a model obtained from reinforcement training.

The feedback collection manager may comprise a starter topic repository that stores a plurality of possible starting points for the interactive information exchange. The automated interactive question generator may be arranged to commence the interactive information exchange using a starter topic from the starter topic repository. The feedback collection manager may be arranged to select starter topic based on a stimulus to which the user is exposed, or based on behavioural response data from the user that is collected during the user's exposure to a stimulus.

### BRIEF DESCRIPTION OF THE DRAWINGS

Embodiments of the invention are discussed in detail below with reference to the accompanying drawings, in which:

FIG. 1 is a schematic diagram of an artificial intelligence (AI)-enhanced feedback collection system that is an embodiment of the invention;

FIG. 2 is a schematic diagram of a feedback collection manager used in the system of FIG. 1;

FIG. 3 is a schematic diagram that illustrates operation of a topic generator module used in the feedback collection manager of FIG. 2; and

FIG. 4 is a flow diagram illustrating a feedback collection method that is an embodiment of the invention.

### DETAILED DESCRIPTION; FURTHER OPTIONS AND PREFERENCES

Embodiments of the invention relate to a system and method of collecting feedback data from a user in response to a certain stimulus, e.g. consumption of a piece of media content, such as a video, advertisement, song, or the like. The stimulus may be any kind of human-computer interaction. The invention may be applicable in any scenario where information is sought in relation to a stimulus or the performance of an action.

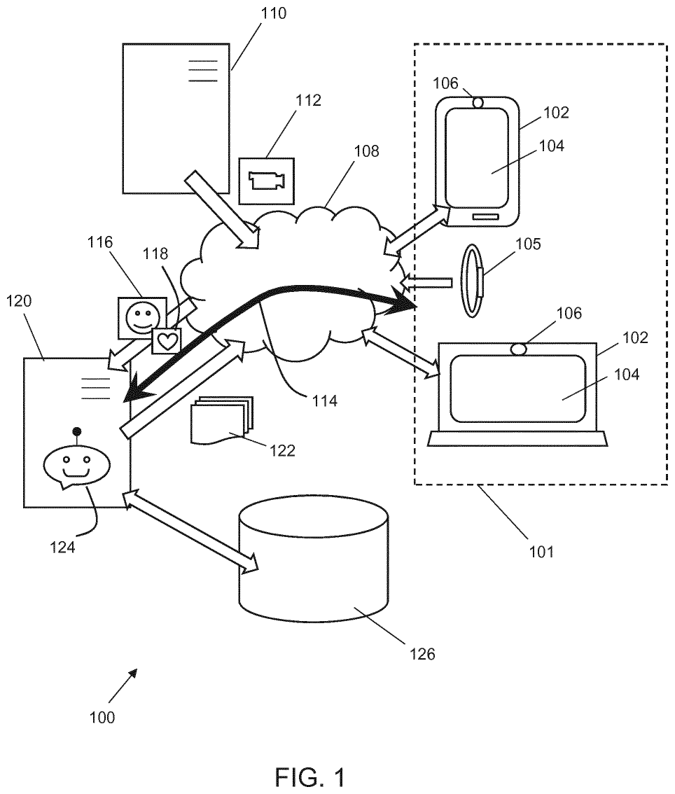

FIG. 1 is a schematic diagram of an feedback collection system 100 that is an embodiment of the invention. The system 100 is provided in a networked computing environment, where a number of processing entities are communicably connected over one or more networks. However, the invention need not be limited to this arrangement. For example, the system may be provide by a single computing device (e.g. PC, laptop, tablet computer, smartphone, or the like).

The system 100 in this example provides three main elements: (i) a content provider for supplying media content to a user environment, (ii) a user environment equipped with means for collecting and communicating user input (such as behavioural data, feedback answer data, etc.), and (iii) a computer-implemented feedback collection capable of communicating over the network to obtain feedback from the user environment.

The system 100 comprises one or more client devices 102 associated with a user environment 101, i.e. belonging to or associated with a given user. The client devices 102 are configured to enable the user to communicate over the network, and may further be configured to playback media content, e.g. via speakers or headphones and/or a display 104. The client devices 102 may also comprise or be connected to behavioural data capture apparatus, such as webcams 106, microphones, etc. Example client devices 102 include smartphones, tablet computers, laptop computers, desktop computers, etc.

The system 100 may also comprise one or more client sensors units, such as a wearable device 105 for collecting physiological information. Examples of physiological parameters that can be measured include voice analysis, heartrate, heartrate variability, electrodermal activity (which may be indicative of arousal), breathing, body temperature, electrocardiogram (ECG) signals, and electroencephalogram (EEG) signals.

The client devices 102 are communicably connected over a network 108, such that they may receive media content 112 to be consumed, e.g. from a content provider server 110. This is one example of a stimulus presented to a user on which feedback can subsequently be collected by the system. However, the invention need not be limited to this feedback. In particular, the stimulus may be supplied outside the networked environment shown in FIG. 1. For example, it may be broadcast media or any other external event.

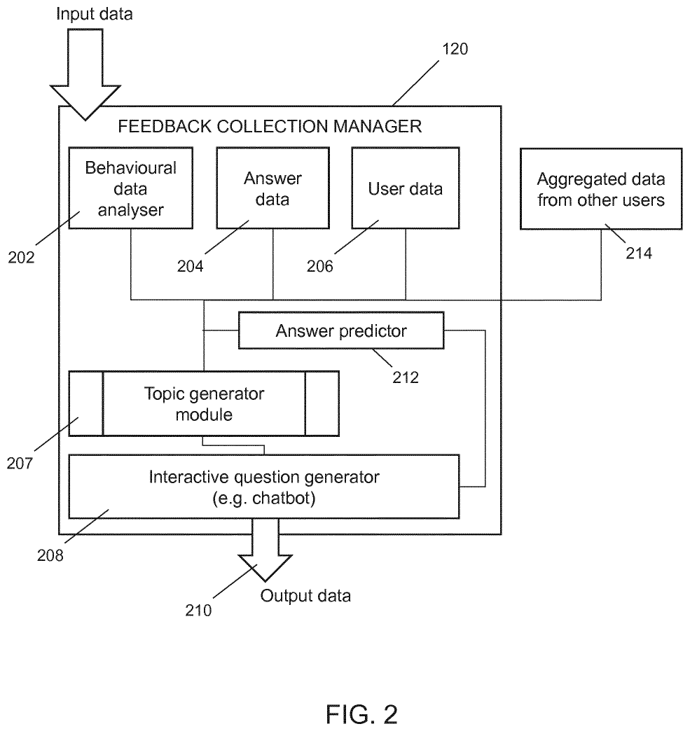

The system 100 is configured to enable a two-way feedback collection interaction 114 between the user environment 101 and a feedback collection manager 120 across the network 108. According to the invention, the feedback collection manager 120 is implemented wholly on a computer, and therefore may not require any human intervention during normal operation to collect feedback. The feedback collection manager 120 is discussed in more detail with respect to FIG. 2. It can be understood that the system is scalable so that multiple users may communication across the network, e.g. to receive content from one or more content providers 110, and to interact with one or more feedback collection managers 120.

During the feedback collection process, the feedback collection manager 120 drives an interactive information exchange in which question and answer data 122 are exchanged between the feedback collection manager 120 and user environment 101. The interactive information exchange may be a dynamic questionnaire that is delivered over a suitable real-time web-based forum. Preferably, the interactive information exchange is a spoken exchange, in which a user hears a spoken question and replies using speech. However, other types of exchange are possible, e.g. text-based exchanges such as a web chat or the like. The feedback collection manager 120 may comprise an information seeking agent 124, which may be an computer-based entity for engaging in dialogue with a user. The information seeking agent 124 may be an AI-based natural language agent, such as Google's Duplex system, or the like. In this example, the information seeking agent 124 is configured to lead the interactive session using information received from the user environment.

The feedback collection manager 120 may utilise machine learning techniques to direct the information seeking agent 124 towards questions on a certain topic or area of interest. For example, the information seeking agent 124 or feedback manager may be provided with or configured with one or more high level objectives. A high level objective may be set for an interaction with a user, and may be aimed at seeking certain information in relation to a known event or stimulus. As described below, the feedback collection manager 120 may input information obtained from the user environment to a topic generator module to yield an output that can be used by the information seeking agent 124 to drive the interactive information exchange with the user, i.e. to provide one or more topics that will form the basis for the questions in the question and answer data 122.

The information seeking agent 124 may be arranged to direct the interactive information exchange in a manner that strikes a balance between the fulfilment of the objective(s) (e.g. based on an amount or quality of information in the received answer data) and the duration of the interactive information exchange. This can be a balance between cost (in terms of user time and system resources) and information maximisation and/or verification. However, other factors may be taken into account. In particular, the user's attentiveness or other measurement of engagement with the interactive information exchange may be used to determine when the exchange can be brought to a close. For example, if a user is detected to have a low level of attentiveness, the information seeking agent 124 may be configured to terminate the interactive information exchange even if it is otherwise desirable to obtain further answer data to fulfil the objective(s).

In one example, the topic generator module may include a topic determination agent that is based on a machine learning world model, i.e. an algorithm trained on a broad range of external data (e.g. news reports, wiki pages, or other data sources that provide information that can be used to derive relations between words and phrases). In combination, the high level objective(s) and user input can be used in conjunction with the world model and/or information relating to the known stimulus, to drive the interactive information exchange with the user.

The topic determination agent may be a supervised learning algorithm that is obtained from training data that includes real human-based feedback interactions (e.g. traditional questionnaires), in which other user data (e.g. behavioural data) is collected during exposure to the stimulus and/or during feedback collection. Emotional state data may be obtained from the behavioural data, as is known. Training data that includes behavioural data of this kind may be included in the world model discussed above.

In another example, the topic determination agent may be based on an adversarial network, in which candidate topics are generated by one network and evaluated by another. In a further example, the topic determination agent may be based on reinforcement learning, e.g. with an objective to learn something specific from the feedback.

The topic determination agent may have access to a list of prescribed topics, whereby the avenues of questioning available in the dynamic questionnaire is bound within the prescribed topics. The list of prescribed topics may be arranged as a local model or topic repository, i.e. containing interrelated threads of information that relate to the prescribed topics, whereby the local model can return threads of information that correlate or match input data in order to assist in determining a query topic. Such a questionnaire may be considered to operate under a global template, although the specific order of topics and line of questioning may be different from user to user. In other examples, however, the topic determination agent may enable the generation and exploration of new topics based on the collected feedback. The generation of new topics may be driven based the underlying objective of the topic determination agent and the world model discussed above. As mentioned above, the local model or topic repository may also include feedback information (i.e. query topics and answer data, including emotional state information) from multiple users who have engaged in an interactive information exchange.

The objectives may be of different types. For example, one objective may be to seek verification of information in previously received feedback. In another example, an objective may be to seek information in relation to a certain target (e.g. an item such as brand name, commercial product, film character, etc.). Where there is a plurality of objectives, the feedback collection manager 120 may include an objective manager that operates to prioritise which objective is to be used for a subsequent query topic. The prioritisation may be done by applying a weighting that favours query topic that correlate to or are otherwise associated with a given objective. The weighting may be dynamically updated during the course of the interactive information exchange. For example, as answer data is obtained that increases the fulfilment of a certain objective, the weighting towards that objective may be reduced so that subsequent query topic are more likely to explore other objectives. The prioritisation of objectives can be achieved in other ways, e.g. through the use of an adversarial network such as an generative adversarial network in which the different objectives are used for the generator and discriminator.

In this example, the client devices 102 are arranged to send behavioural information and/or physiological data over the network for use by the feedback collection manager 120. The behavioural information and/or physiological data that is transmitted may be collected during exposure to the stimulus, whereby the feedback collection manager 120 is provided with some initial information regarding the user's response to that stimulus. Additionally or alternatively, the behavioural information and/or physiological data that is transmitted may be collected in real time during the interactive information exchange with the information seeking agent 124. In this case, the behavioural information and/or physiological data can be used to inform the line of questioning, i.e. the generation of topics by the topic determination agent.

References to “behavioral data” or “behavioral information” herein may refer to visual aspects of a user's response. For example, behavioral information may include facial response, head and body gestures or pose, and gaze tracking.

In this example, the information sent to the feedback collection manager 120 may include a user's facial response 116, e.g. in the form or a video or set of images captured of the user during exposure to the stimulus. Where the image frames depict facial features, e.g. mouth, eyes, eyebrows etc. of a user, and each facial feature comprises a plurality of facial landmarks, the behavioural data may include information indicative of position, shape, orientation, shading etc. of the facial landmarks for each image frame.

The image data may be processed on respective client devices 102, or may be streamed to the feedback collection manager 120 over the network 108 for processing.

The facial features may provide descriptor data points indicative of position, shape, orientation, sharing, etc., of a selected plurality of the facial landmarks. Each facial feature descriptor data point may encode information that is indicative of a plurality of facial landmarks. Each facial feature descriptor data point may be associated with a respective frame, e.g. a respective image frame from the time series of image frames. Each facial feature descriptor data point may be a multi-dimensional data point, each component of the multi-dimensional data point being indicative of a respective facial landmark.

The emotional state information may be obtained directly from the raw data input, from the extracted descriptor data points or from a combination of the two. For example, the plurality of facial landmarks may be selected to include information capable of characterizing user emotion. In one example, the emotional state data may be determined by applying a classifier to one or more facial feature descriptor data points in one image or across a series of images. In some examples, deep learning techniques can be utilised to yield emotional state data from the raw data input.

The user emotional state may include one or more emotional states selected from anger, disgust, fear, happiness, sadness, and surprise.

The information may also include the associated media content 112 or a link or other identifier that enables the feedback collection manager 120 to access the media content 112 that was consumed by the user.

The information sent to the feedback collection manager 120 to may also include physiological data 118, e.g. transmitted directly by the wearable device 105, or by one or the client devices 102 if the wearable device 105 is paired therewith. The client devices 102 may be arranged to process raw data from the wearable device, whereby the physiological data 114 transmitted to the feedback collection manager 120 may comprise data already processed by the client device 102.

The feedback information collected by the feedback collection manager is stored in data storage 126. The feedback data may be associated with the behavioural data that was obtained during the collection process. Combined feedback and behavioural data of this kind from multiple users can be stored and made available as another type of input for the topic determination agent, as discussed below.

FIG. 2 is a schematic diagram that illustrates operation of the feedback collection manager 120. At a high level, the feedback collection manager 120 receives input data from the user environment 101 and processes it to generate a topic or list of topics from which an interactive question generator 208, such as the information seeking agent 124 discussed above, generates and outputs data 210 in the form of the next stage in the interactive information exchange with the user.

As shown in FIG. 2, the input data may comprise a plurality of different data types. A first data type may be the behavioural and/or physiological information received from the user environment 101. The feedback collection manager 120 may comprise a behavioural data analyser 202 that is arranged to extract emotional state information from the received behavioural and/or physiological information.

A second data type is answer data 204, which is information received from the user during the interactive information exchange, e.g. in reply to questions issued by the information seeking agent. The feedback collection manager 120 may be arranged to perform syntactical and semantic analysis on the answer data to extract relevant information therefrom.

A third data type is user data 206, which may be profile information about the user, e.g. demographic and/or geographic information, and/or information concerning the user's preferences, etc.

A fourth data type is aggregated data 214 from other users. This may be useful, for example, in enabling a comparison of a current user's answer and emotional state in replying to a certain question with similar information obtained across a plurality of users. This may enable identification of unusual replies, which in some circumstances may indicate new avenues or topics for questioning.

The various data types may be input to a topic generator module 207, which executes the topic determination agent discussed above to determine one or more topics (e.g. subject or intention) for subsequent questioning. This information is fed to the information seeking agent to formulate a suitable interaction. In one example, the feedback collection manager 120 may use the answer data 204 and extracted emotion state information to perform sentiment analysis. The results of the sentiment analysis can be supplied to the information seeking agent to facilitate formulation of a suitable interaction.

In a further development, the topic generator module may also take account of a predicted answer in the determination of a topic for questioning. For example, an output from the topic generator module may be a plurality of candidate avenues for pursuing the interactive information exchange. The candidate avenues may generally comprise any of (i) pursuing questioning on current topic (e.g. explore previous answer, to verify it or obtain more information), (ii) open questioning on new topic, or (iii) finish the exchange. For specifically, each candidate avenue may comprise a particular topic to be explored. For example, under (i), the continued questioning might be to try to understand the cause of an observed emotional state, or to try to resolve conflicting data.

The plurality of candidate avenues may all be supplied to the interactive question generator 208, which can generate corresponding candidate interactions, which in turn are supplied to an answer predictor 212. The answer predictor 212 may comprise a machine learning model that is trained to predict user replies to questions. The output from the answer predictor 212 may be used to select one of the candidate interactions to send to the user. Additionally or alternatively, the output from the answer predictor 212 may be compared (e.g. by the topic determination agent) with the actually obtained answer. This comparison may enable unexpected replies to be identified and explored.

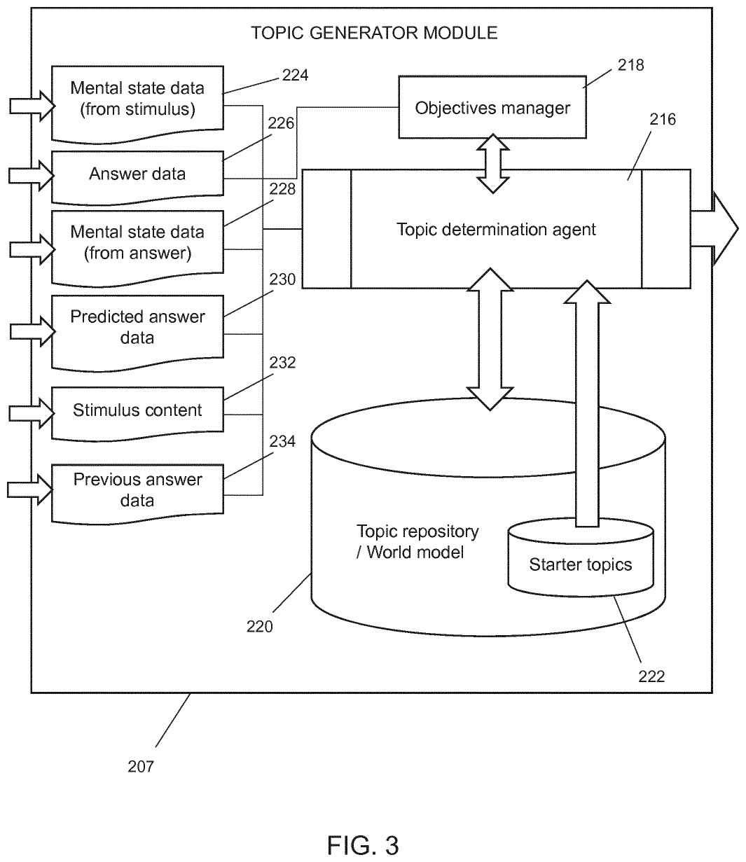

FIG. 3 is a schematic diagram that illustrates operation of the topic generator module 207. The topic determination agent 216 discussed above is an algorithm, e.g. executed by one or more processors in a comparator engine, which receives a plurality of data types as input. As explained above, the input data may comprise any one or more or all of answer data 226, mental state data 228 obtained while provided the answer data, predicted answer data 230 (e.g. from answer predictor 212), stimulus content data 232 (e.g. relating to the media content or other stimulus for which feedback is desired), mental state data 224 obtained while exposed to the stimulus, and previous answer data 234 (i.e. data indicative of the course of the current interactive information exchange). The topic determination agent 216 is coupled to a topic repository or world model 220. The topic repository or world model 220 effectively acts a data pool within which the input data is used to generate a corresponding topic that assists in achieving one or more objectives from an objectives manager 218. The objective(s) represents the aim(s) of the feedback collection. The topic determination agent 216 uses the input data to obtain output data that is correlated with the input data in the topic repository/world model 220. The topic determination agent 216 is arranged to judge, using the objective(s) from the objective manager 218, which output data is appropriate for fulfilment of an objective, and then passes this data to the interactive question generator as the next query topic.

As discussed above, in one example each objective may have an associated weighting, whereby the judgement performed by the topic determination agent can prioritise output data for one objective over others. The objectives manager 218 may be configured to monitor the received answer data to assess an extent to which each objective is fulfilled. The objectives manager 218 may adjust weighting of the objectives based on the received answer data, e.g. to prioritise objectives for which insufficient answer data is received. The weighting for objectives may be determined by other factors, e.g. external input.

In one example, the topic repository/world model 220 may comprise a database of available avenues for the interactive information exchange. The topic repository 220 may be static, i.e. a fixed set of topics, or may be updatable to include new avenues based on the answer data. The topic determination agent 216 is arranged to generate one or more relevant topics based on the input data. The result from the model is supplied to the interactive question generator.

In another example, the topic repository/world model 220 represents a world model vector space in which the content from the training set is positioned by relevance. The topic determination agent 216 may operate to assemble one or more query vectors using the input data (i.e. user response data and data relating to the stimulus). The topic determination agent may generate an output topic that is based on similar vectors in the world model vector space. The world model vector space may be configurable depending on the context. For example, if the feedback required concerned a certain type of product, the world model could be limited to information related to such products. In this way the world model may be tailored to the subject matter or context of the feedback collection process.

The topic repository/world model 220 also includes a repository 222 that stores one or more predetermined starter topics that can be used to initiate the interactive information exchange. The starter topic may be the same for all users, or may be selectable, e.g. based on the mental state data collected for the user while exposed to the stimulus.

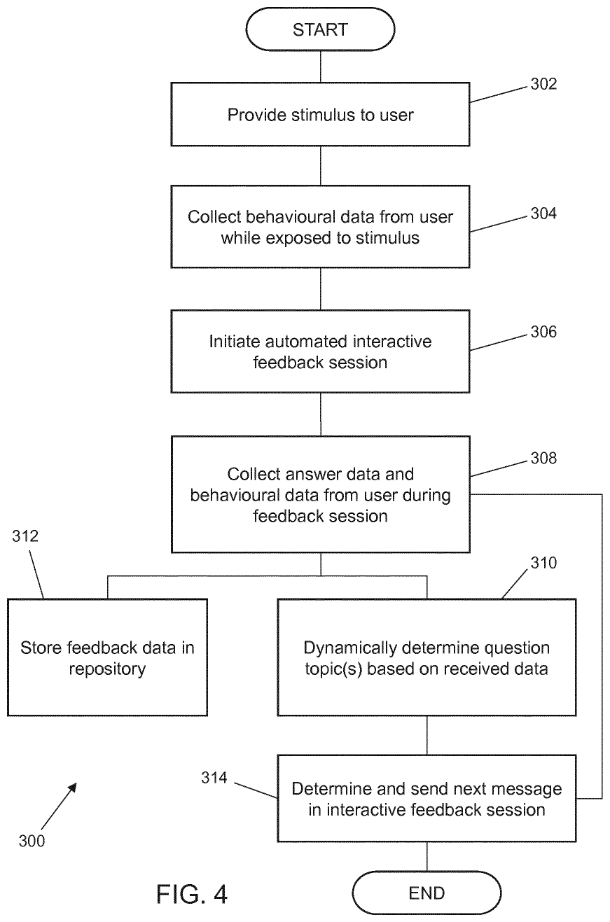

FIG. 4 is a flow diagram illustrating a feedback collection method 300 that is an embodiment of the invention. The method 300 begins with a step 302 of providing a stimulus to a user. This may be communicating, over a network, media content such as a video or the like, for playback on a suitable user device.

The method continues with a step 304 of collecting behavioural and/or physiological data from the user while exposed to the stimulus, e.g. during playback of the media content. The behavioural data may comprise image data (e.g. of the user's face) collected by a webcam or the like, and audio data collected from a microphone. The physiological data may be obtained using a wearable sensor.

The method continues with a step 306 of initiating an automated interactive feedback session between the user and the feedback collection manager discussed above. The initiation step may be triggered by sending an electronic message to the user other the network (e.g. via email, or through a messaging application). The automated interactive feedback session may comprise a exchange of messages between the user and feedback collection manager. The messages may comprise any one or more of text, audio data (e.g. speech) and video data. The interactive feedback session may take the form of a dynamic questionnaire in which the feedback collection manager requests information from (e.g. poses questions to) the user.

The method continues with a step 308 of collecting answer data and behavioural and/or physiological data from the user during participation in the feedback session. The collected behavioural and/or physiological data may thus supplement the textual, audio and/or video data that constitutes the user's reply (i.e. the answer data). The method may include a step 312 of storing the collected answer data and behavioural and/or physiological data (collectively referred to as “feedback data”) in a suitable repository.

As explained above, the feedback collection manager is fully automated, and operates on the basis of an AI-based interaction control algorithm that determines the direction and topics for the interactive information exchange. The method continues with a step 310 of dynamically selecting, using the interaction control algorithm (also referred to above as a topic determination agent), an aim or topic for a subsequent question in the interactive information exchange. The method continues with a step 314 of determining and sending a next message in the interactive feedback session based on the topics determined at the previous step. This step may be performed by a chatbot or the like that is configured to assemble message content (e.g. language, syntax and sentiment) based on an input aim or topic.

Upon determining that all relevant topics are exhausted, or based on some other termination criteria, the method may end by terminating the interactive feedback session. The termination criteria may comprise session duration, or user engagement level being below a threshold. The user engagement level may be determined based on collected behavioural data.

In use, the feedback collection process of the invention provides by which pertinent feedback information can be obtained in an efficient manner from users. The process enables dynamic targeting of questioning in an informed (and repeatable) manner by utilising a machine learning algorithm that is responsive to different types of answer data. This enables the direction of questioning to be influenced by the user replies in a consistent way. This is an improvement compared with inflexible fixed questionnaire scripts, which do not permit exploration of unusual or ambiguous replies. It is also an improvement compared with a freeform feedback process, where the lack of structure makes aggregation and summarising difficult and time-consuming.

Moreover, by being sensitive to behavioural data during the collection of feedback, the process may enable “non-useful” feedback, e.g. from a disengaged user, to be filtered efficiently. In one example, this manifests as early termination of the interactive feedback session, which may save network resources and prevent the topic determination agent from becoming distorted.

1. A computer-implemented system for collecting user feedback, the system comprising:
a client device configured to collect and communicate feedback information from a user; and
a feedback collection manager communicatively connected over a network with the client device to receive the feedback information,
wherein the feedback collection manager comprises:
an AI-based topic generator configured to generate, using the feedback information received from the client device, a query topic; and
an automated interactive question generator for directing an interactive information exchange with the client device using the generated query topic.

2. The system of claim 1, wherein the feedback information collected by the client device comprises answer data received in response to a question from the automated interactive question generator, and behavioural data collected from the user when providing the answer data.

3. The system of claim 2, wherein the answer data comprises a spoken response from the user.

4. The system of claim 2, wherein the behavioural data comprises emotional state data for the user.

5. The system of claim 4, wherein the feedback information collected by the client device comprises facial images of the user, and the emotional state data is extracted from the facial images.

6. The system of any one of claim 2, wherein the feedback collection manager is arranged to detect, based on the behavioural data collected from the user when providing the answer data, a sentiment associated with the answer data, and the automated interactive question generator is arranged to use both the detected sentiment and the generated query topic in the interactive information exchange with the client device.

7. The system of claim 1, wherein the automated interactive question generator comprises a natural conversation module arranged to engage in interactive dialogue with the user.

8. The system of any one of claim 2, wherein the behavioural data comprises physiological data for the user.

9. The system of claim 2, wherein the feedback information is in relation to the user's exposure to a stimulus, and the client device is further configured to collect the behavioural data from the user during the user's exposure to the stimulus.

10. The system of claim 9, wherein the feedback information communicated by the client device includes the behavioural data.

11. The system of claim 1, wherein the feedback collection manager is arranged to receive the feedback information relating to different users from a plurality of client devices.

12. The system of claim 1, wherein the AI-based topic generator module comprises a topic repository and a topic determination agent coupled to the topic repository, wherein the AI-based topic generator module is configured to:
extract input data from the feedback information;
process the input data by the topic determination agent to generate output data that is indicative of the query topic.

13. The system of claim 12, wherein the topic repository comprises a world model from which the topic determination agent is arranged to output a new query topic based on the input data.

14. The system of claim 12, wherein the topic repository comprises a database of previously received feedback information from which the topic determination agent is arranged to generate output data that is indicative of a related query topic based on the input data.

15. The system of claim 12, wherein the topic determination agent is arranged to compare the output data with an objective, and select the query topic based on the result of the comparison.

16. The system of claim 12, wherein the topic determination agent comprises a machine learning algorithm that uses a model selected from the set of models consisting of a supervised learning model, a adversarial network model and a model obtained from reinforcement training.

17. The system of claim 1, wherein the feedback collection manager comprises a starter topic repository and the automated interactive question generator is arranged to commence the interactive information exchange by selecting a starter topic for use from the starter topic repository.

18. The system of claim 17, wherein the starter topic is selected based on a stimulus to which the user is exposed.

19. The system of claim 18, wherein the starter topic is selected based on behavioural response data from the user that is collected during the user's exposure to the stimulus.
